(19) United States
(12) Patent Application Publication
(10) Pub. No.: US 2015/0206354 A1
(43) Pub. Date: Jul. 23, 2015

(54) IMAGE PROCESSING APPARATUS AND IMAGE DISPLAY APPARATUS

(71) Applicant: Sharp Kabushiki Kaisha, Osaka-shi, Osaka (JP)

(72) Inventors: Nao Shibuhisa, Osaka-shi (JP); Kei Tokui, Osaka-shi (JP)

(73) Assignee: Sharp Kabushiki Kaisha, Osaka-shi, Osaka (JP)

(21) Appl. No.: 14/423,485

(22) PCT Filed: Aug. 23, 2013
(86) PCT No.: PCT/JP2013/072546

§ 371 Date: Feb. 24, 2015

(30) Foreign Application Priority Data
Aug. 30, 2012 (JP) 2012-189900

(51) Int. Cl. G06T 19/20; H04N 7/14; H04N 13/00; H04N 5/232; G06T 7/00; G06K 9/00

(52) U.S. Cl. CPC G06T 19/20; G06T 7/0046; G06K 9/00248; H04N 13/0007; H04N 5/23293; H04N 7/141; H04N 13/0059

(57) ABSTRACT

The present invention provides a technology of generating a preferable self-photographing image when performing self-photographing in which an imaging direction of an imaging unit and a display direction of a display unit are aligned.

An image processing apparatus includes a face information detection unit, a face direction calculation unit, an image parallel shift unit, a face model generation unit, and an image generation unit. In the face information detection unit, a face position information, face size information, and face component information of an object are detected. In the face direction calculation unit, face direction information of the object is calculated based on an arrangement of the face component information. In the image parallel shift unit, an image is shifted in parallel so that a face position of the object matches an image center. In the face model generation unit, face stereoscopic shape template information is converted into a face model which is suitable for a face of the object based on the face size information and the face direction information. In the image generation unit, an image in which the face of the object is converted into a front face based on a face model is generated.

### TECHNICAL FIELD

The present invention relates to an image processing apparatus which generates a preferable self-photographing image when performing so-called self-photographing in which an imaging direction of an imaging unit and a display direction of a display unit are aligned, and an image display apparatus which includes the image processing apparatus.

### BACKGROUND ART

There is so-called self-photographing in which one's own face is photographed as an object by setting an imaging direction of an imaging unit and a display direction of a display unit to the same direction in various display devices such as a mobile phone, a tablet, a notebook computer, a television, or the like.

There are two representative applications of the self-photographing as follows. One is video chatting or a function of a TV conference in which it is possible to have a conversation with a partner at a remote place by displaying a captured image on a display which the partner at the remote place has. The other is a mirror function in which it is possible to perform work such as applying make-up in which it is necessary to view one's own face by performing a display of a mirror image, by reversing the left and right sides of a captured image.

Since a face of a partner is displayed on a display unit in video chatting, and one's own face is displayed on the display unit in a mirror function, a user takes a look at the display unit, not an imaging unit. Since a gaze direction of an object which is imaged and an imaging direction of the imaging unit do not match each other, it enters a state in which the imaged object does not face the front side, and the object and a gaze do not match even when a partner at a remote place or the object himself views a captured image. As a method of correcting a face direction of the object, for example, PTL 1 discloses a method of generating an image of an object which faces the imaging unit by arranging a plurality of imaging means on the outer side portion of a display screen of an image display unit in a distributing manner, and obtaining a three-dimensional image by processing the image of the object from a plurality of imaging data items which are obtained using the respective imaging means.

### CITATION LIST

### Patent Literature

PTL 1: Japanese Unexamined Patent Application Publication No. 2004-159061

### SUMMARY OF INVENTION

### Technical Problem

However, in the above described method, an imaged object is corrected to an image in which the object usually faces a display screen. For example, an image is corrected to an image facing the display screen even when it is desired to image a profile of an object, and it is difficult to generate a preferable self-photographing image.

The present invention has been made so as to solve the above described problem, and to provide an image processing apparatus which generates a preferable self-photographing image when performing so-called self-photographing in which an imaging direction of an imaging unit and a display direction of a display unit are aligned.

### Solution to Problem

According to an aspect of the present invention, there is provided an image processing apparatus which includes a face information detection unit which detects face position information, face size information, and face component information of an object from image data; a face direction calculation unit which calculates face direction information of the object from the face position information, the face size information, and the face component information; an image parallel shift unit which shifts the image data in parallel so that the face position information becomes a center of the image data; a face model generation unit which generates a face model of the object by transforming face stereoscopic shape template information which denotes a stereoscopic shape of a face based on the face position information, the face size information, the face component information, and the face direction information; and an image generation unit which generates an image in which the face of the object is converted so as to be a front face based on the face direction information and the face model, in which a process of outputting image data which is shifted in parallel using the image parallel shift unit, and a process of outputting image data which is generated using the image generation unit are switched according to the face direction information.

According to another aspect of the present invention, there is provided an image display apparatus which includes an imaging unit which images an object; the image processing apparatus which processes image data of the object which is imaged using the imaging unit; and a transmission unit which transmits an image which is generated in the image processing apparatus.

According to still another aspect, there is provided an image display apparatus which includes an imaging unit which images an object; the image processing apparatus which processes image data of the object which is imaged using the imaging unit; and a reception unit which receives image data which is generated in another image display apparatus to which an imaging unit is attached.

### Advantageous Effects of Invention

According to the present invention, it is possible to appropriately perform image processing according to a face direction of an object, and to generate a preferable self-photographing image when performing so-called self-photographing in which an imaging direction of an imaging unit and a display direction of a display unit are aligned.

### BRIEF DESCRIPTION OF DRAWINGS

FIG. 1 is a diagram which illustrates a system configuration of a first embodiment of an image display apparatus which includes an image processing apparatus according to the present invention.

FIG. 2 is a diagram which illustrates face component information, face size information, and face position information which are detected using a face information detection unit.

FIG. 3 is a diagram which illustrates a relationship between the face direction information and an arrangement of eyes of an object.

FIG. 4 is a diagram which illustrates an angle which is formed by a face direction of the object and an imaging direction of an imaging unit.

FIG. 5 is a diagram which illustrates operations of an image parallel shift unit.

FIG. 6 is a diagram which illustrates operations of the image parallel shift unit.

FIG. 7 is a diagram which illustrates face stereoscopic shape template information which is used when generating a face model.

FIG. 8 is a diagram which illustrates a generated face model.

FIG. 9 is a diagram which illustrates operations of an image generation unit.

FIG. 10 is a flowchart which illustrates operations in the first embodiment of the present invention.

FIG. 11 is a diagram which illustrates a system configuration of a second embodiment of an image display apparatus which includes the image processing apparatus of the present invention.

### DESCRIPTION OF EMBODIMENTS

Hereinafter, embodiments of the present invention will be described with reference to accompanying drawings. In addition, accompanying drawings illustrate specific embodiments and mounting examples based on the principle of the present invention; however, these are for understanding the present invention, and are not for limiting the present invention. In addition, a configuration in each figure is illustrated in an exaggerated manner for ease of understanding, and is different from an actual interval or an actual size.

### First Embodiment

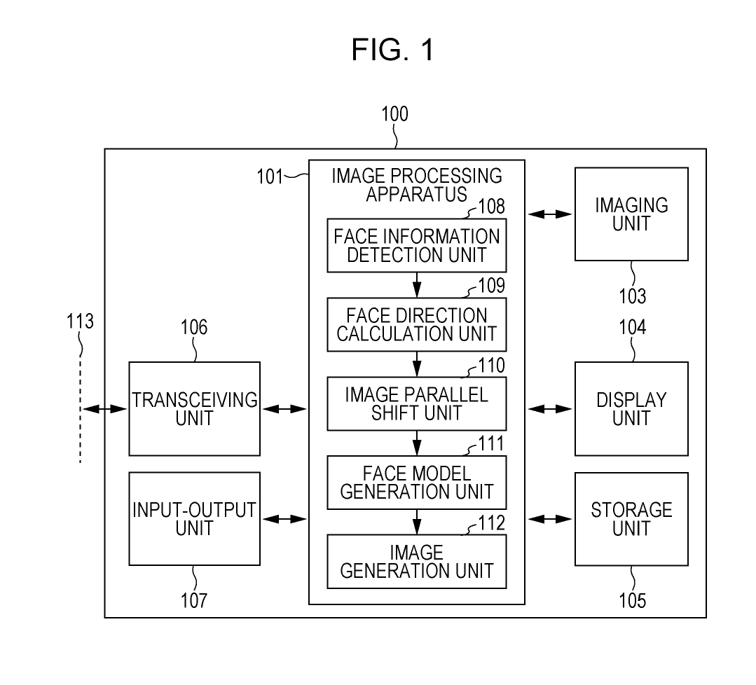

FIG. 1 is a diagram which illustrates an embodiment of an image display apparatus 100 which includes an image processing apparatus 101 according to the present invention, and illustrates an example in a case in which an object is self-photographed using the image display apparatus 100, a preferable self-photographing image is generated from the photographed self image, and the generated image is displayed on a display unit 104.

Hereinafter, details of a system configuration and operations of a first embodiment of the present invention will be described in detail using FIG. 1. The image display apparatus 100 according to the embodiment is a communication terminal such as a mobile phone with a camera, a tablet, or the like, for example, and can perform capturing of an image or preserving, transmitting, and the like, of the captured image.

The image display apparatus 100 includes an imaging unit 103, a display unit 104, a storage unit 105, an image processing apparatus 101, a transceiving unit 106, and an input-output unit 107. In addition, the image display apparatus 100 is connected to an external network 113 through the transceiving unit 106, and is connected to another communication device, or the like.

The imaging unit 103 includes an imaging lens, and an imaging element such as a Charge Coupled Device (CCD), a Complementary Metal Oxide Semiconductor (CMOS), or the like, and can image a still image or a motion picture of an object.

The display unit 104 is a display screen such as a liquid crystal display (LCD), an organic Electro Luminescence (EL) display, or the like, and displays information such as an image, characters, or an image of an object, or the like.

The image processing apparatus 101 can be configured of, for example, a Central Processing Unit (CPU), a Graphic Processing Unit (GPU), or the like, obtains and processes information such as an image, text, sound, or the like, from the imaging unit 103, the storage unit 105, the input-output unit 107, the transceiving unit 106, or the like, and outputs the information after processing to the display unit 104, the storage unit 105, or the like.

In addition, the image processing apparatus 101 includes a face information detection unit 108, a face direction calculation unit 109, an image parallel shift unit 110, a face model generation unit 111, and an image generation unit 112. The face information detection unit 108 extracts face information (face position information, face size information, and face component information of object, that is, features of a face such as eyes, nose, mouth, or the like) from image data which is input from the image processing apparatus 101.

The face direction calculation unit 109 calculates face direction information of an object based on face information which is detected using the face information detection unit 108. In addition, the image parallel shift unit 110 shifts a face region of image data in parallel so that the detected face position information of the object becomes an image center.

The face model generation unit 111 generates a face model corresponding to an object based on the face information which is detected using the face information detection unit 108, the face direction information which is calculated using the face direction calculation unit 109, and the face stereoscopic shape template information. The face stereoscopic shape template information will be described later. In addition, the image generation unit 112 corrects a face of the object so as to be a front face based on the face direction information and the face model.

The storage unit 105 is a flash memory or a hard disk, for example, and stores an image, the face stereoscopic shape template information, or the like, or preserves unique data of the device. In addition, the input-output unit 107 is a unit such as a sound input-output device such as a key button, a microphone, a speaker, or the like, and inputs a command, voice, or the like, of a user to the image processing apparatus 101, or outputs voice. In addition, the transceiving unit 106 is a communication unit of a mobile phone, a cable, or the like, and transmits and receives image data, data which is necessary when generating an image, the face stereoscopic shape template information, or the like, to and from the outside. Hitherto, the system configuration according to the first embodiment has been described.

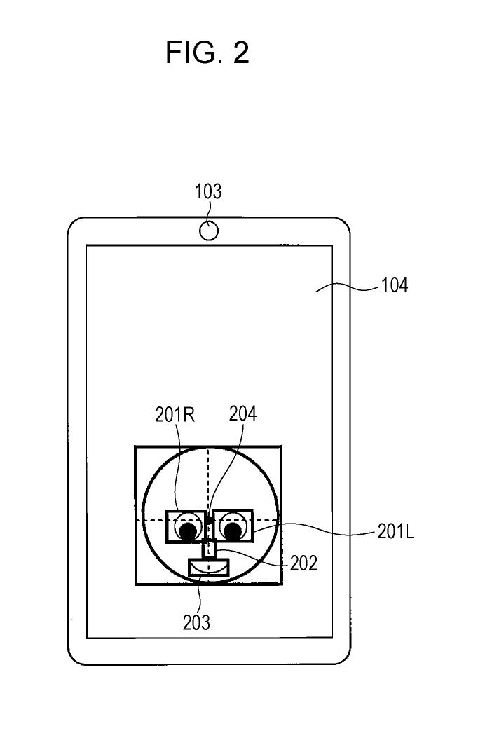

Subsequently, operations of the image display apparatus 100 according to the first embodiment will be described in detail using FIGS. 2 to 9. First, operations of detecting face information will be described using FIG. 2. FIG. 2 is a diagram which illustrates the face component information, the face size information, and the face position information which are detected using the face information detection unit 108.

The face information detection unit 108 detects the face position information, the face size information, and the face component information (that is, features of a face such as eyes (201L and 201R), nose 202, mouth 203, or the like, of object) as face information of an object from the image data. Here, the face position information is a center position 204 of a detected face region. The face size information is the number of horizontal pixels and vertical pixels in a detected face region. That is, the center position 204 in the face region is a position which becomes (x, y)=(w_k/2, h_k/2) when the horizontal direction of the face region is set to an x axis, the vertical direction is set to a y axis, the upper left side in the face region is set to the origin (x, y)=(0, 0), a vertical resolution of the face region is set to h_k, and a horizontal resolution is set to w_k.

As a method of detecting the face position information 204, the face size information, and the face component information (both eyes 201L and 201R, nose 202, mouth 203, or the like) from image data in the detected face region, there is a method of detecting eyes, a nose, a mouth, or the like, using pattern matching, after specifying a face region by detecting a skin color, and a method of detecting the face position information and the face component information by statistically obtaining a discriminant function from a learning sample of a plurality of face images and images other than a face (not face) (P. Viola and M. Jones, “Rapid object detection using a boosting cascade of simple features”, Proc. IEEE Conf. CVPR, pp. 511-518, 2001), and the above described methods may be used. In this manner, the detection of the face component information is performed.

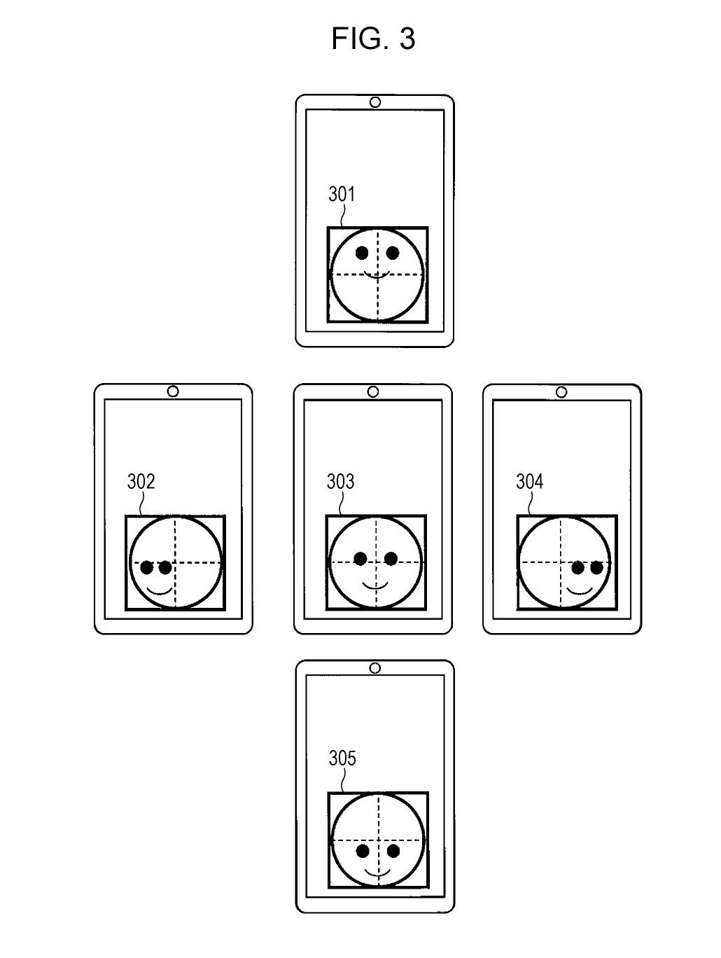

Subsequently, operations of calculating a face direction will be described with reference to FIG. 3. FIG. 3 is a diagram which illustrates a relationship between the face direction information and an arrangement of eyes of an object.

The face direction calculation unit 109 calculates face direction information of an object based on face information which is detected using the face information detection unit 108. The face direction calculation unit 109 detects a face direction of an object from the face position information, the face size information, and the face component information (eyes, nose, mouth, or the like) of the object which are detected from a captured image. As a method of determining a face direction using the face position information or the face component information such as eyes, a nose, a mouth, or the like, which is detected from an image, there is a method of pattern matching with face images facing various directions, and a method of using a positional relationship of the face component information. Here, the method of using a positional relationship of the face component information will be described.

There are relationships illustrated in FIG. 3 between a face direction and a position of face component information in a face region. Frames 301 to 305 in FIG. 3 are face regions of objects which are cut out using the face position information and the face size information. As illustrated in FIG. 3, a face region is divided into four parts, and a direction toward which face component information of an object is biased is calculated as the face direction information of the object.

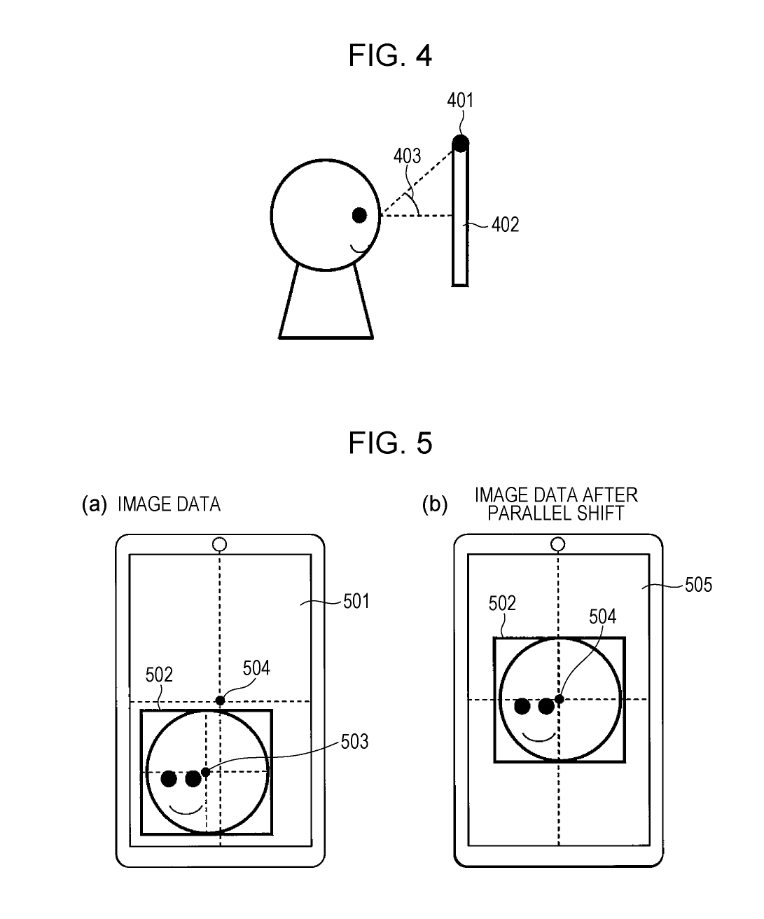

Since face component information is biased upward in the face region 301, it is determined that the face direction is an upward direction. In addition, since face component information is biased to the left in the face region 302, it is determined that the face direction is a leftward direction. In addition, since face component information is biased to the right in the face region 304, it is determined that the face direction is a rightward direction. In addition, since face component information is biased downward in the face region 305, it is determined that the face direction is a downward direction. At this time, when an angle 403 in which a face image which is a front face forms 0 degrees is calculated as a face direction, in a case in which an imaging unit 401 and a display unit 402 are arranged at different positions as illustrated in FIG. 4, a front face image with a higher quality can be generated at a time of image generation which will be described later, and accordingly, it is preferable. The front face is a face image which is captured in a state in which an object faces the imaging unit (103 or 401).

Here, a calculation of a face direction is performed based only on a positional relationship of left and right eyes in the face region; however, when face component information of a nose, a mouth, or the like, other than eyes is used, it is possible to improve accuracy of calculation of a face direction, and accordingly, it is preferable. In this manner, a calculation of a face direction is performed.

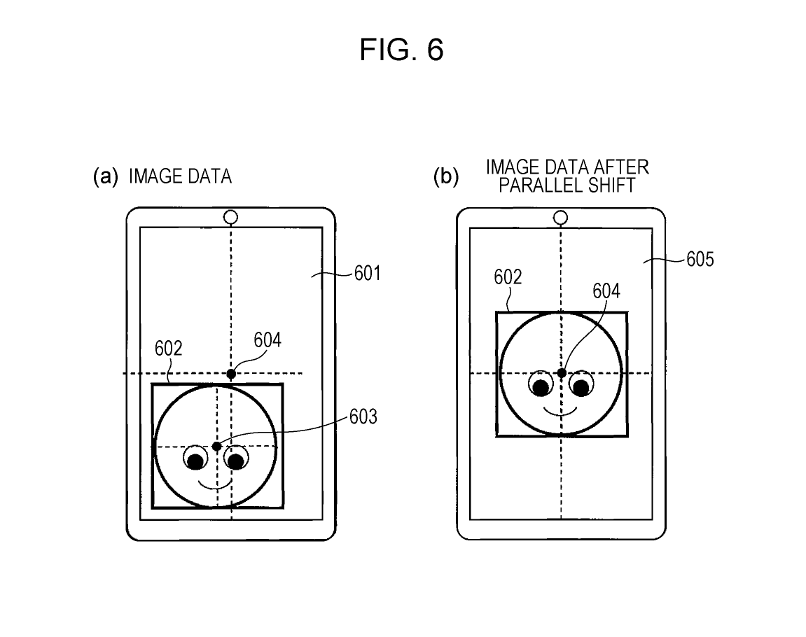

Subsequently, the image parallel shift operation will be described using FIGS. 5 and 6. FIG. 5 is a diagram which illustrates operations of the image parallel shift unit 110, and is an example of a case in which a face direction of an object is a lateral direction. The image parallel shift unit 110 shifts image data 501 in parallel so that face position information 503 on the image data 501 becomes an image center 504. The image center 504 is a position which becomes (x, y)=(w/2, h/2) when a horizontal direction of an image is set to an x axis, a vertical direction is set to a y axis, the upper left side of the image is set to the origin (x, y)=(0, 0), a vertical resolution of the image is set to h, and a horizontal resolution is set to w.

FIG. 6 is a diagram which illustrates operations of the image parallel shift unit 110, and is an example when a face direction of an object is other than the lateral direction. As illustrated in FIG. 6, the image parallel shift unit 110 shifts image data 601 in parallel so that face position information 603 on the image data 601 becomes an image center 604.

In FIGS. 5 and 6, in the image data 505 or 605 after being shifted in parallel, the face region 502 or 602 of the object is displayed at the center of a screen, and a preferable image which is easy to view for a user is generated. At this time, when a resolution in image data is larger than a resolution in the display unit 104, a region outside of a view angle does not appear when the face position information is shifted in parallel, and accordingly, it is preferable. When a region outside of a view angle appears, interpolation with respect to the region outside of the view angle is performed using a method of displaying a black color in the region outside of the view angle, a method of drawing out an image end, and a method in which a region in the vicinity of the image end is displayed by being folded.

In addition, when a smoothing filter or a median filter is applied to detected face position information of an object in a time axis direction, a minute change in the face position information of the object is suppressed when being applied to a motion picture or a successively captured image, a face image is displayed at a fixed position, and accordingly, it is preferable. In addition, a moment in which face position information is remarkably changed is detected by calculating a secondary derivative of detected face position information in the time axis direction, and a smoothing process is performed only when the face position information is minutely changed. In this manner, when face position information is greatly moved so as to follow a position change in a case in which the face position information is remarkably changed, and when a minute change is suppressed in a case in which the face position information repeats the minute change, a face image is displayed at a fixed position, and accordingly, it is preferable. It is also possible to obtain the above described same effect in the face direction of an object, not only in the face position information of an object.

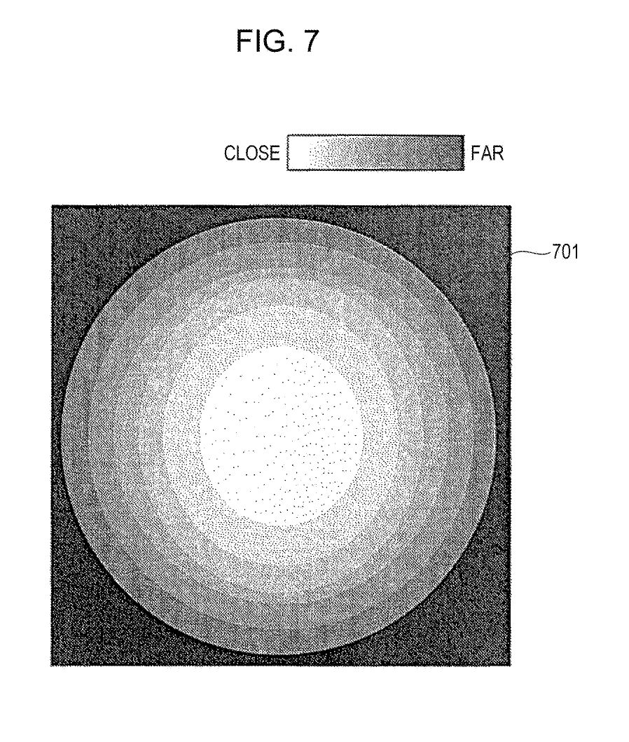

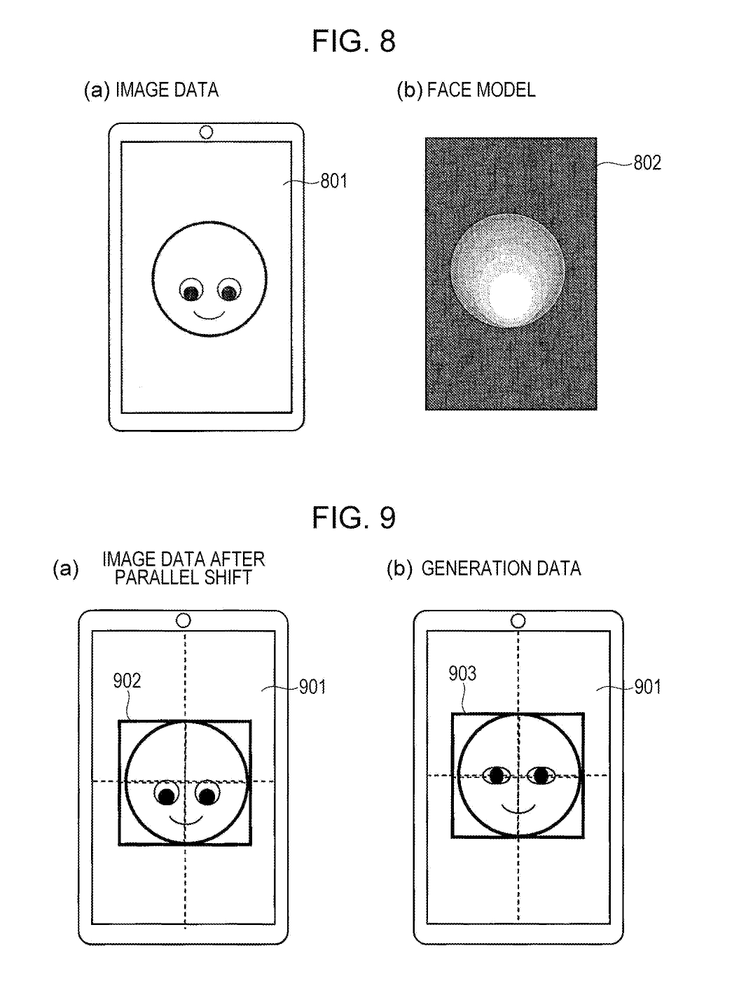

Subsequently, operations of generating a face model will be described using FIGS. 7 and 8. FIG. 7 is a diagram which illustrates face stereoscopic shape template information which is used when generating a face model. The face model generation unit 111 generates a face model using the face size information which is detected using the face information detection unit 108, a direction of a face which is calculated using the face direction calculation unit 109, and the face stereoscopic shape template information, and outputs the generated face model to the image generation unit 112. In addition, image data as a processing target of the face model generation unit 111 is image data after being subjected to a parallel shift process using the image parallel shift unit 110.

Here, the face stereoscopic shape template information which expresses a stereoscopic shape of a face which is used when generating a face model will be described in detail. The face stereoscopic shape template information is data in which a stereoscopic shape of a face is recorded as illustrated in FIG. 7. Here, a face of an object is expressed as a ball for simple expression. The face stereoscopic shape template information is a person's average face, and can be created by averaging stereoscopic shapes of faces which are obtained from samples of a plurality of persons. In addition, it is also possible to create the face stereoscopic shape template information using computer graphics (CG). The face stereoscopic shape template information 701 which is illustrated in FIG. 7 is an image which is obtained by storing a distance between the image display apparatus 100 and a face in each pixel, and expresses a stereoscopic shape of a face using a luminance value. A distance of a face portion which is close to the image display apparatus 100 is short, and a distance of an object which is far from the image display apparatus 100 is long. Here, in the shorter distance, the face portion is expressed using bright pixels, and in the longer distance, the face portion is expressed using dark pixels. Generation of a face model is performed using the face stereoscopic shape template information.

First, size information of the face stereoscopic shape template information is caused to match face size information which is detected. That is, the face stereoscopic shape template information is expanded or compressed so that a vertical resolution and a horizontal resolution of the face stereoscopic shape template information become equal to a vertical resolution and a horizontal resolution of a detected face region. By performing expanding or compressing, the face stereoscopic shape template information with approximately the same size as that of the face size information is transformed so as to have the same face direction of the object.

That is, a position in a three-dimensional space in an image is converted using the face stereoscopic shape template information, that is, distance data of a face. An upward face model is generated when a face direction is an upward direction, and a downward face model is generated when a face direction is a downward direction, and the face model is output to the image generation unit 112.

FIG. 8 illustrates a face model 802 which is generated with respect to image data 801 as a downward object. Here, descriptions are made when the face direction information is the upward direction or the downward direction; however, when a face model is generated using a face direction such as a left and right direction, or a lower right direction in which those are compounded is generated, not only the upward direction or the downward direction, it is possible to generate a higher quality front face image at a time of image generation which will be described later, and accordingly, it is preferable. In this manner, generation of a face model is performed.

The above described method is preferable, since it is not necessary to add a new sensor to the image display apparatus 100 in order to obtain a stereoscopic face shape of an object, or to execute a complicated process such as a stereoscopic shape calculating process, a face model of an object is generated using a simple system, and the face model can be used when generating a front face of an object. In addition, when face stereoscopic shape template information and position information of face component information thereof are detected, and the face stereoscopic shape template information is transformed so that the position information of the face component information of the face stereoscopic shape template information and position information of face component information of a detected face region match each other, it is possible to generate a higher quality front face image at a time of image generation which will be described later, and accordingly, it is preferable.

Lastly, operations in image generation will be described using FIG. 9. FIG. 9 is a diagram which illustrates operations in image generation in a case in which a face direction is a direction other than the lateral direction. The image generation unit 112 generates a front face 903 of an object using face direction information and a face model. In addition, image data 901 which is a processing target of the image generation unit 112 is image data after being subjected to a parallel shift process using the image parallel shift unit 110. In this manner, an image in which a face of an object faces the front side, and a face region is displayed at the image center is generated.

Subsequently, a method of generating a front face will be described. Image data of which a face direction is a front direction is generated by converting a position of image data of which a face direction is not the front direction in a three-dimensional space in an image, using a face model, that is, distance data of a face. The position conversion in the three-dimensional space is performed based on a face direction which is used in the face model generation unit 111. That is, when a face model which is shifted downward by 5 degrees (face stereoscopic shape template information after correction) is generated in the face model generation unit 111, a face image which is shifted upward by 5 degrees is generated in the image generation unit 112, and the generated image is output as image data of which a face direction is a front direction. In this manner, in the image generation unit 112, image data after the parallel shift is converted into a position on a face model, and pixels on the image data are corrected so that an amount of an inclined angle on the face model is corrected.

The face model generation process in the face model generation unit 111, and the image generation process in the image generation unit 112 are executed when face direction information of an object is less than a threshold value. The threshold value is a degree of inclination of a face of an object. The smaller the value, the more the object faces the front side. That is, it means that the object faces the imaging unit 103, and when the value is large, the object is deviated from the front side, that is, the object does not face the imaging unit 103. For example, when a state in which face direction information of an object is the lateral direction is set to a threshold value, a value less than the threshold value denotes a state in which a face direction of an object is the front direction rather than the lateral direction, and a value which is the threshold value or more denotes a state in which the face direction of the object is deviated from the front side compared to the lateral direction. When the face direction information of the object is less than the threshold value, a face image in which a face direction of the object is converted into a front face is displayed at an image center, and when the face direction information of the object is the threshold value or more, a face image of which the face direction is not converted is displayed at the image center. When the face direction is the lateral direction, it denotes a state in which a face direction of an object is greatly deviated from the front side, for example, a state in which both eyes of the object are biased to the horizontal direction of the face region, a state in which only one eye is viewed, or the like.

In addition, it is determined that a face direction of an object is a threshold value or more when a face of the object is greatly inclined toward the vertical direction, toward the horizontal direction, or a composite state thereof, by also setting the upward direction, the downward direction, or the like, to the threshold value, not only the lateral direction. For example, when a face of an object is greatly inclined toward the downward direction, it is determined that the object desires to show the top of the head, and a process of displaying the face at a center of a screen is performed by shifting the image data in parallel with respect to the face, without setting to a front face. It is possible to reduce a processing amount, and to generate an image which is easy to view, and is intended by a user, by switching a process of outputting image data which was subjected to a parallel shift corresponding to a face direction of an object, and a process of outputting image data which was converted so that the face of the object becomes a front face, as described above.

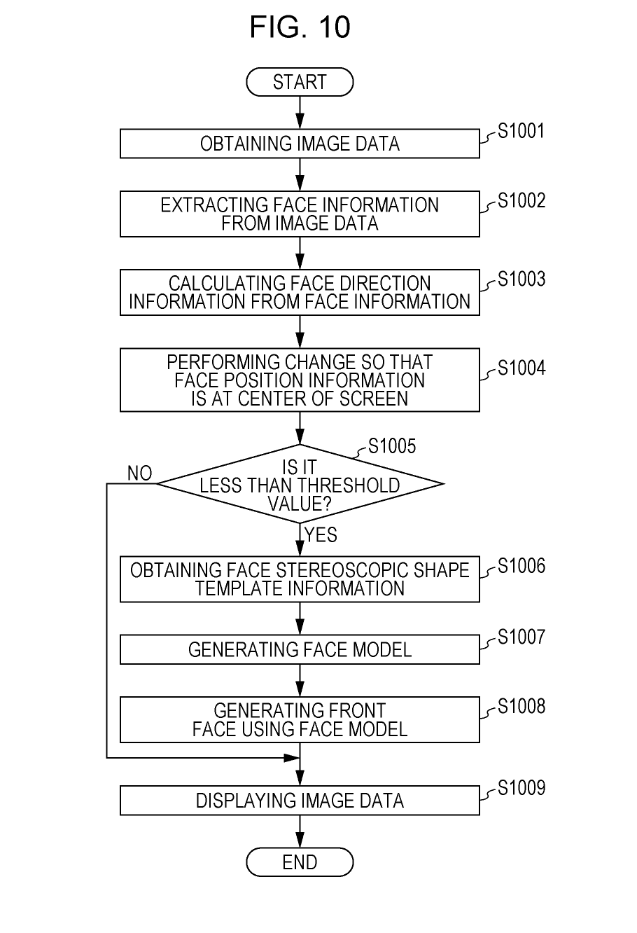

Hereinafter, a flow of the above described operations will be described using the flowchart illustrated in FIG. 10.

First, in step S1001, the image processing apparatus 101 takes in captured image data from the imaging unit 103, the transceiving unit 106, or the like. Subsequently, in step S1002, the face information detection unit 108 detects face information such as the face size information, the face position information, the face component information, or the like, from the captured image data. Subsequently, in step S1003, the face direction calculation unit 109 calculates a face direction of an object using the face information.

Subsequently, in step S1004, the image parallel shift unit 110 performs the parallel shift with respect to all of images so that face position information becomes an image center. Here, in step S1005, the face model generation unit 111 performs a determination on whether or not face direction information is less than a threshold value, and when the face direction information is less than the threshold value, face stereoscopic shape template information is obtained in step S1006. Subsequently, in step S1007, the face model generation unit 111 generates a face model. When generating a face model, the face stereoscopic shape template information is converted according to face size information and face direction information, and the face model is generated.

Subsequently, in step S1008, the image generation unit 112 generates an image in which a face of an object in image data becomes a front face using the generated face model. In addition, in step S1009, the image generation unit 112 outputs the generated image to the display unit 104. In addition, when the face direction information is a threshold value or more, an image in which the entire image is shifted in parallel so that the face position information becomes an image center is output as a generated image. Hitherto, the flow of operations of the image processing apparatus 101 has been described. In this manner, the image display apparatus 100 according to the first embodiment is operated.

According to the embodiment, an image which is generated in the image processing apparatus 101 included in the image display apparatus 100 is displayed on the display unit 104; however, it may be a configuration in which an image which is generated in another image display apparatus including the image processing apparatus 101 according to the present invention is received in the transceiving unit 106, and is displayed on the display unit 104. According to the configuration, a television conference with people at a remote place, video chatting, or the like, is possible, and accordingly, it is preferable.

According to the image display apparatus 100 which includes the image processing apparatus 101 in the present invention, it is possible to appropriately perform image processing according to a face direction of an object, and to display a preferable self-photographing image.

In addition, in the embodiment, a case in which there is one piece of face stereoscopic shape template information has been described; however, appropriate information may be selected from a plurality of pieces of face stereoscopic shape template information. For example, face information such as an eye width, an arrangement of face component information, or a face shape of an object is analyzed from detected face component information, face size information, or the like, age, a face shape, or a stereoscopic shape of the face such as a sharpness of the face is assumed, and face stereoscopic shape template information which is closest to the assumed stereoscopic shape of the face is selected. In this manner, since image processing is performed using face stereoscopic shape template information which is suitable for a user, it is possible to improve generated image quality, and it is preferable.

In addition, in a case in which there are at least two or more pieces of face stereoscopic shape template information which are similar to a stereoscopic face shape of a user, it is possible to generate a suitable face model using a stereoscopic face shape of a user, by generating intermediate face stereoscopic shape template information which becomes intermediate information of the two or more pieces of face stereoscopic shape template information, and accordingly, it is preferable. The intermediate face stereoscopic shape template information is generated by performing morphing with respect to two or more pieces of face stereoscopic shape template information. In a case in which a stereoscopic face shape of a user is similar to face stereoscopic shape template information A by 45%, and is similar to face stereoscopic shape template information B by 55%, morphing is performed according to the similarity of rates. Since it is possible to generate a suitable face model using a stereoscopic face shape of a user by generating face stereoscopic shape template information which is suitable for the user using morphing, from a plurality of pieces of face stereoscopic shape template information, it is preferable.

In addition, since there is no large fluctuation in selection of template information between the face stereoscopic shape template information A and the face stereoscopic shape template information B, it is possible to eliminate a sense of unease which occurs in a generated image when the selected template information is suddenly switched, and it is preferable. In addition, when a degree of similarity is calculated in each face component information of a user, since it is possible to generate a face model which is more suitable for a stereoscopic face shape of a user, for example, face stereoscopic shape template information C is used in a shape of eyes, and face stereoscopic shape template information D is used in the outlines of the face, it is preferable.

### Second Embodiment

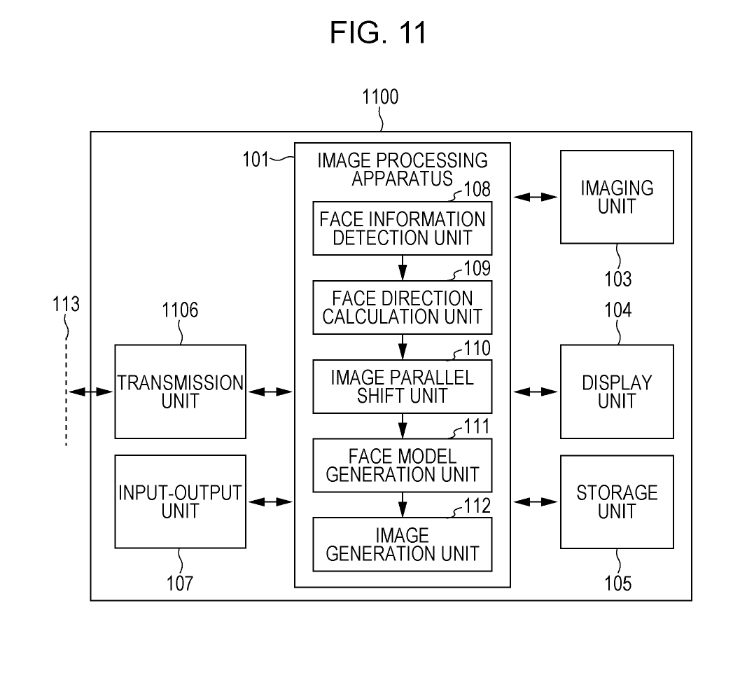

Subsequently, a configuration of an image display apparatus according to a second embodiment of the present invention will be described using FIG. 11. In FIG. 11, the same configuration elements as those in FIG. 1 are given the same reference numerals, and descriptions of these configuration elements will be omitted, since the same processes as those in the embodiment in FIG. 1 are performed.

A difference between the embodiment and the first embodiment is that the transceiving unit 106 is replaced by a transmission unit 1106. Operations thereof are approximately the same as those in the first embodiment, captured image data is preserved or transmitted, and it is an image display apparatus 1100 which is exclusive for transmission. In addition, a configuration in which the transmission unit 1106 in FIG. 11 is omitted is also taken into consideration. In this case, it is an apparatus in which only an imaging display and a preservation of a corrected image are performed without performing a communication.

In the second embodiment, a relationship between a display unit 104 and an imaging unit 103 is uniquely determined, and the imaging unit 103 is provided at the upper portion of an outer frame of the display unit 104. In a case of this configuration, since an object image which is imaged using the imaging unit 103 is usually directed downward, face stereoscopic shape template information can be limited to a downward face. In addition, when the imaging unit 103 is provided at the lower portion of the outer frame of the display unit 104, since an object image which is imaged using the imaging unit 103 is usually directed upward, face stereoscopic shape template information can be limited to an upward face. As described above, since a direction of a face of face stereoscopic shape template information which is preserved using a positional relationship is uniquely determined, it is possible to generate a face model without changing a face direction by reading out face stereoscopic shape template information at a time of generating a face model, by preserving upward face stereoscopic shape template information, and downward face stereoscopic shape template information in the storage unit 105. That is, in the second embodiment, there is an advantage that a face direction of face stereoscopic shape template information is not necessary to be converted, and accordingly, a process amount is reduced, in the face model generation unit 111.

As described above, it is possible to perform displaying, preserving, and transmitting while viewing the display unit 104 when performing self-photographing, and to generate a preferable self-photographing image in the image display apparatuses 100 and 1100 including the image processing apparatus 101, and in a communication device in which the image display apparatuses are used.

In addition, the present invention is not restrictively interpreted according to the above described embodiments, can be variously changed in a range of matters which are described in claims, and is included in a technical range of the present invention.

A program which is operated in the image processing apparatus 101 according to the present invention may be a program which controls a CPU, or the like, (program which causes computer to function) so as to execute functions of the above described embodiments which are related to the present invention. In addition, information which is handled in the apparatus is temporarily accumulated in a Random Access Memory (RAM) at a time of processing, is stored in various ROMs such as a Flash Read Only Memory (ROM), or an HDD thereafter, and is subjected to reading, correcting and rewriting by a CPU as necessary.

In addition, it may be a configuration in which a program for executing functions of each configuration in FIG. 1 is recorded in a computer-readable recoding medium, the program which is recorded in the recording medium is read using a computer system, and processing of each unit is performed when a CPU, or the like executes the program. In addition, the “computer system” here includes hardware such an OS, a peripheral device, or the like. In addition, the “computer-readable recoding medium” is a portable medium such as a flexible disk, a magneto-optical disc, a ROM, and a CD-ROM, and a storage unit such as a hard disk which is built into a computer system. In addition, the “computer-readable recoding medium” also includes a recording medium which dynamically holds a program for a short time like a communication line when the program is transmitted through a network such as the Internet, a telephone line, or the like, and a recording medium which holds the program for a fixed time like a volatile memory in the computer system which becomes a server or a client in that case.

In addition, a part or the entirety of the image processing apparatus 101 in the above described embodiments may be typically realized as an LSI which is an integrated circuit. Each function block of the image processing apparatus 101 may be made into a chip, individually, or a part or all thereof may be made into a chip by being integrated. In addition, a method of making into the integrated circuit is not limited to the LSI, and may be executed in a dedicated circuit, or a general-purpose processor. In addition, when a technology of making into the integrated circuit substituting for the LSI appears due to progress of the semiconductor technology, it is also possible to use the integrated circuit using the present technology.

In addition, in the above described embodiments, a control line or an information line is illustrated since it is necessary for description, and all of control lines or information lines are not necessarily illustrated in a product. All configurations may be connected to one another.

### REFERENCE SIGNS LIST

100 IMAGE DISPLAY APPARATUS
101 IMAGE PROCESSING APPARATUS
103 IMAGING UNIT
104 DISPLAY UNIT
105 STORAGE UNIT
106 TRANSCEIVING UNIT
107 INPUT-OUTPUT UNIT
108 FACE INFORMATION DETECTION UNIT
109 FACE DIRECTION CALCULATION UNIT
110 IMAGE PARALLEL SHIFT UNIT
111 FACE MODEL GENERATION UNIT
112 IMAGE GENERATION UNIT
113 EXTERNAL NETWORK
1100 IMAGE DISPLAY APPARATUS
1106 TRANSMISSION UNIT

1-8. (canceled)

9: An image processing apparatus comprising:
a face information detection unit which detects face position information, face size information, and face component information of an object from image data;
a face direction calculation unit which calculates face direction information of the object from the face position information, the face size information, and the face component information;
an image parallel shift unit which shifts the image data in parallel so that the face position information becomes a center of the image data;
a face model generation unit which generates a face model of the object by transforming face stereoscopic shape template information which denotes a stereoscopic shape of a face based on the face position information, the face size information, the face component information, and the face direction information, and
an image generation unit which generates an image in which a face of the object is converted so as to be a front face based on the face direction information and the face model,
wherein, in a case in which it is determined that inclination of the face is greatly inclined in a vertical direction and a horizontal direction by comparing the face direction information and a predetermined threshold value which denotes a degree of inclination of the face of the object, image data which is shifted in parallel using the image parallel shift unit is output, and in a case in which it is determined that inclination of the face faces a front side, image data which is generated using the image generation unit is output.

10: The image processing apparatus according to claim 9,
wherein the image parallel shift unit performs smoothing of the face position information in a time axis direction.

11: The image processing apparatus according to claim 9,
wherein the face model generation unit includes a plurality of pieces of face stereoscopic shape template information, and
wherein, in a case in which two or more pieces of face stereoscopic shape template information which are close to the object are selected, the face model generation unit generates intermediate face stereoscopic shape template information based on the two or more pieces of face stereoscopic shape template information.

12: The image processing apparatus according to claim 10,
wherein the face model generation unit includes a plurality of pieces of face stereoscopic shape template information, and
wherein, in a case in which two or more pieces of face stereoscopic shape template information which are close to the object are selected, the face model generation unit generates intermediate face stereoscopic shape template information based on the two or more pieces of face stereoscopic shape template information.

13: An image display apparatus comprising:
an imaging unit which images an object;
the image processing apparatus according to claim 9 which processes image data of the object which is imaged in the imaging unit; and
a transmission unit which transmits an image which is generated in the image processing apparatus.

14: An image display apparatus comprising:
an imaging unit which images an object;
the image processing apparatus according to claim 9 which processes image data of the object which is imaged in the imaging unit;
a reception unit which receives image data generated in another image display apparatus to which an imaging unit is attached; and
a display unit which displays the image data which is received in the reception unit.
